(19) United States
(12) Patent Application Publication
(10) Pub. No.: US 2020/0384396 A1
(43) Pub. Date: Dec. 10, 2020

(54) FILTER AIDS FOR TREATING OIL AND METHODS OF PREPARATION AND USE THEREOF

(71) Applicant: IMERYS USA, INC., Roswell, GA (US)

(72) Inventors: Andrew OH, Sacramento, CA (US); Li-Chih HU, Sacramento, CA (US)

(21) Appl. No.: 15/733,227

(22) PCT Filed: Dec. 14, 2018
(86) PCT No.: PCT/US2018/065631

§ 371 Date: Jun. 12, 2020

Related U.S. Application Data
(60) Provisional application No. 62/598,728, filed on Dec. 14, 2017.

(51) Int. Cl. B01D 39/06; B01J 20/10; B01J 20/14; B01J 20/32; B01J 20/28; C11B 3/10

(52) U.S. Cl. CPC B01D 39/06; B01J 20/103; B01J 20/14; B01J 20/3204; B01J 20/3234; C11B 3/10; B01J 20/28011; B01J 20/28059; B01J 20/28061; B01J 20/28085; B01J 20/28004

(57) ABSTRACT

The present disclosure includes compositions and methods for filtering oil, e.g., for removing free fatty acids (FFAs) from an oil used for cooking. In one example, the composition may comprise a filter aid that includes an alkali silicate, and a composite material comprising a silicate mineral at least partially coated with an inorganic silica or silicate. In another example, filter aid includes an alkali silicate, and a silicate mineral, wherein at least a portion of the alkali silicate is present as a coating on the silicate mineral, and wherein the ratio of said alkali silicate to silicate mineral in the filter aid ranges from about 1:4 to 4:1 by weight. In yet another example, the filter aid includes an alkali silicate, a silicate mineral, and an adsorbent. The method of filtering an oil may include combining the oil with the filter aid, optionally heating the mixture, and separating at least a portion of the filter aid from the oil to thereby remove at least a portion of the FFAs from the oil.

### CLAIM FOR PRIORITY

This PCT International Application claims the benefit of priority of U.S. Provisional Application Nos. 62/598,728, filed Dec. 14, 2017, the subject matter of which is incorporated herein by reference in its entirety.

### TECHNICAL FIELD

Embodiments of the present disclosure relate generally to compositions useful as filter aids, such as for filtering oil. The compositions may comprise a filter aid comprising a composite silicate material and an alkali silicate.

### BACKGROUND

The use of cooking oil for frying foods results in several forms of oil contamination, e.g., via hydrolysis, oxidation, and/or polymerization. Moisture present in food during cooking forms steam, which together with oxygen can initiate chemical reactions producing free fatty acids (FFAs). An exemplary mechanism by which FFAs are generated from triglycerides is shown below.

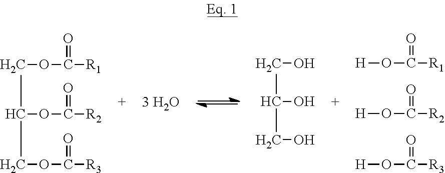

The amount of FFAs in a cooking oil tends to increase with use (repeated frying). FFAs have a detrimental effect on oil quality, such as decreasing oxidative stability of the oil and/or leading to foods that are off-flavor. As such, FFA content can provide an indication of the quality of an oil. Compositions and methods capable of reducing the FFA content of cooking oils therefore may be of interest.

### SUMMARY OF THE DISCLOSURE

The present disclosure includes filter aids, methods of use thereof, and methods of preparation thereof. For example, in one example the present disclosure includes a filter aid comprising: (a) an alkali silicate, and (b) a composite material comprising a silicate mineral at least partially coated with an inorganic silica or silicate. In another example, the present disclosure includes a filter aid comprising: (a) an alkali silicate, and (b) a silicate mineral, wherein at least a portion of the alkali silicate is present as a coating on the silicate mineral, and wherein the ratio of said alkali silicate to silicate mineral in the filter aid ranges from about 1:4 to 4:1 by weight. In yet another example, the present disclosure includes a filter aid comprising an alkali silicate, a silicate mineral, and an adsorbent.

In one example, the present disclosure includes a filter aid comprising an alkali silicate, and a composite material comprising a silicate mineral at least partially coated with an inorganic silica or silicate. The alkali silicate may comprise, for example, a sodium silicate, a potassium silicate, or a mixture thereof. In some examples, the alkali silicate comprises sodium metasilicate, such as, e.g., sodium metasilicate pentahydrate, sodium metasilicate nonahydrate, anhydrous sodium metasilicate, or a mixture thereof. For example, the filter aid may comprise from about 10% to about 75% by weight of sodium metasilicate pentahydrate.

In one example, the filter aid includes from about 10 to about 70% by weight of alkali silicate. In another example, the filter aid includes from about 10% to about 60% by weight alkali silicate, about 10% to about 60% by weight silicate mineral, and about 10 to about 60% by weight adsorbent.

Additionally or alternatively, the silicate mineral of the filter aid may comprise biogenic silica (such as, e.g., diatomaceous earth), perlite, pumice, pumicite, obsidian, pitchstone, volcanic ash, or a combination thereof. Further, for example, the inorganic silica or silicate may comprise silica gel, sodium silicate, magnesium silicate, or a combination thereof. In at least one example, the inorganic silica or silicate is precipitated onto a surface of the silicate mineral. According to some examples herein, the composite material of the filter aid comprises from about 50% to about 95% by weight of biogenic silica and/or from about 5% to about 80% by weight of the inorganic silica or silicate with respect to the total weight of the composite material. In some examples, the alkali silicate may be present as loose particles, e.g., powder, combined with the composite material to form the filter aid. In some examples, the alkali silicate may comprise a different compound or mixture of compounds than the inorganic silica or silicate of the composite material.

In one example, the filter aid can include at least one adsorbent. In some examples, the adsorbent can be at least partially coated onto the silicate mineral. In other examples, the adsorbent can be a particulate material substantially unbound from the silicate mineral. In many examples, the adsorbent can be a magnesium silicate.

The filter aid may have a permeability ranging from about 0.05 darcy to about 10.0 darcy and/or a BET surface area ranging from about 0.2 m²/g to about 450 m²/g. In some examples, the particle size distribution of the composite material in the filter aid has a d₅₀ diameter ranging from about 5 μm to about 300 μm. Further, in some examples, the filter aid may have a bimodal particle size distribution, In some examples, the composite material may have a median pore diameter (4V/A) ranging from about 0.1 μm to about 10.0 μm and/or a wet density ranging from about 5 lb/ft³ to about 30 lb/ft³. In at least one example, the filter aid comprises from about 0.5% to about 10% by weight water, with respect to the total weight of the filter aid.

Further included herein are compositions comprising the filter aids discussed above and elsewhere herein, For example, the composition may comprise at least 80% by filter aid and from about 1.0% by weight to about 10.0% by weight water, with respect to the total weight of the composition. In some examples, the composition (e.g., an aqueous composition) has a pH ranging from about 9.0 to about 13.0. In some examples, the composition is in the form of dry particulate matter. In another example, the filter aid comprises from about 0.5% to about 20% by weight water, with respect to the total weight of the filter aid, such as for example from about 1% to about 10% by weight water.

The present disclosure also includes methods of filtering an oil using such filter aids and/or compositions. For example, the method may include combining the oil with a filter aid to form a mixture, the filter aid comprising an alkali silicate and a composite material comprising a silicate mineral at least partially coated with an inorganic silica or silicate. As mentioned above, the alkali silicate may comprise a sodium silicate, a potassium silicate, or a mixture thereof. For example, the filter aid may comprise sodium metasilicate, e.g., sodium metasilicate pentahydrate, sodium metasilicate nonahydrate, anhydrous sodium metasilicate, or a mixture thereof.

According to some aspects of the present disclosure, the method of filtering further comprises heating the mixture comprising the oil and filter aid. The oil may comprise free fatty acids, such as, e.g., from about 0.05% to about 10.0% by weight free fatty acids, The method may further comprise separating at least a portion of the filter aid from the oil, wherein the filter aid removes at least 50%, at least 65%, or at least 70% by weight of the free fatty acids from the oil. The oil may comprise an edible oil, such as oils derived from animals and/or plants. In some examples, the mixture comprises from about 0.05% to about 10.0% of the filter aid relative to the weight of the oil.

The present disclosure also includes methods of making such filter aids. For example, the method may comprise preparing a composite material by at least partially coating a silicate mineral with an inorganic silica or silicate; and combining the composite material with an alkali silicate. The alkali silicate may comprise a sodium silicate, a potassium silicate, or a mixture thereof. For example, the alkali silicate may comprise sodium metasilicate, e.g., sodium metasilicate pentahydrate, sodium metasilicate nonahydrate, anhydrous sodium metasilicate, or a mixture thereof. Additionally or alternatively, the silicate mineral may comprise diatomaceous earth, wherein preparing the composite material comprises precipitating the inorganic silica or silicate onto a surface of the diatomaceous earth. In at least one example, the method further comprises adding water to the filter aid, such that the filter aid comprises from about 0.5% to about 10% by weight water, with respect to the total weight of the filter aid.

In another example, the method of making a filter aid includes coating an alkali silicate onto a silicate mineral substrate. In one example, the coating can be accomplished using a rotary mixer, a pan pelletizer. In another example the coating can be accomplished using a spray drying process. In some examples, the method of making a filter aid can include mixing an adsorbent with the alkali silicate and silicate mineral,

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

The present disclosure includes filter aids useful for filtration of oils, e.g., edible oils or other oils used for cooking or frying, to remove contaminants such as FFAs. The filter aids herein may comprise at least one silica or silicate, or combinations of multiple types of silicas/silicates, which may be biogenic or inorganic.

In some examples herein, the filter aid comprises a silicate mineral at least partially coated, or fully coated, with a silica or silicate to form a composite material, wherein the substrate optionally comprises a silicate material different from the coating. The coated silicate mineral may further be combined with another silicate compound, such as an alkali silicate, e.g., sodium silicate, such as sodium metasilicate.

In other examples, the filter aid comprises an alkali silicate coated silicate mineral, such as for example a sodium silicate-coated diatomite or a sodium silicate coated perlite. For example, the filter aid can include an alkali silicate, and a silicate mineral, wherein at least a portion of the alkali silicate is present as a coating on the silicate mineral, and wherein the ratio of said alkali silicate to silicate mineral in the filter aid ranges from about 1:4 to 4:1 by weight.

In other examples, the filter aid comprises an alkali silicate, a silicate mineral, and an adsorbent. The adsorbent can be for example an alkaline earth metal silicate such as for example a magnesium silicate.

Without intending to be bound by theory, it is believed that the combination of silicates of the filter aid may provide functional synergy in filtering oils, e.g., to maintain or improve the quality of oils used in cooking, such as frying oils. In some examples, filtering may comprise combining the oil with the filter aid to form a mixture. Such filtering may allow for removal of FFAs by neutralizing the FFAs with the alkali silicate (e.g., sodium silicate) of the filter aid, forming salts:

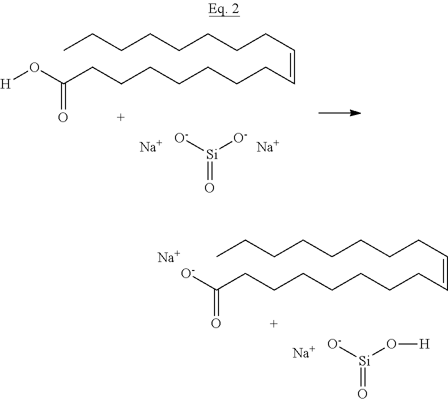

The FFA salts (generally referred to as soap) may adsorb to the coated silicate mineral particles of the filter aid. For example, the FFA salts may physically and/or chemical adhere to the coated silicate mineral particles, allowing for removal of the FFAs by filtering the particles from the oil.

According to some aspects of the present disclosure, the filter aid comprises an alkali silicate, such as, e.g., sodium silicate, potassium silicate, or a mixture thereof. For example, the filter aid may comprise sodium silicate ((Na₂SiO₂)ₙO), wherein the molar ratio SiO₂:Na₂O ranges from 1.0 to 4.0. The alkali silicate may be hydrated or anhydrous. In some examples, the sodium silicate comprises sodium metasilicate (Na₂SiO₃), having a molar ratio SiO₂:Na20 of 1.0. For example, the filter aid may comprise anhydrous sodium metasilicate and/or a hydrated form of sodium metasilicate such as sodium metasilicate pentahydrate (Na₂SiO₃.5H₂O), sodium metasilicate nonahydrate (Na₂SiO₃.9H₂O), any other hydrated forms, or a mixture thereof. In at least one example, the sodium silicate comprises sodium metasilicate pentahydrate. In at least one example, the sodium silicate comprises sodium metasilicate nonahydrate.

In some examples, the alkali silicate may be in powder form, e.g., the filter aid further comprising a particulate material (e.g., silicate mineral particles at least partially or fully coated by silica or silicate), e.g., a composite material. Thus, at least a portion of the alkali silicate may be unattached to the silicate mineral particles or otherwise unassociated with the coating of the silicate mineral particles, e.g., the alkali silicate being present in the form of free particles. For example, the filter aid may comprise particles with a bimodal distribution (e.g., corresponding to the particle size distribution of the free alkali silicate and the particle size distribution of the composite material). Further, for example, the alkali silicate may comprise a different compound or mixture of compounds than the inorganic silica or silicate of the composite material. For example, the filter aid may comprise sodium silicate and/or potassium silicate, and the coating of the composite material may comprise silica gel. In another example, the coating of the composite material may comprise sodium silicate, and the alkali silicate may comprise a sodium silicate different than the coating (e.g., a different hydrated form, a different molar ratio of SiO₂/Na₂O, anhydrous vs. hydrated, etc.).

In some examples, the filter aid may comprise from about 5% to about 80% by weight of the alkali silicate, such as from about 10% to about 75% by weight, from about 15% to about 70% by weight, from about 10% to about 20%, from about 5% to about 25%, from about 20% to about 60% by weight, from about 25% to about 50% by weight, from about 30% to about 65% by weight, or from about 50% to about 75% by weight, with respect to the total weight of the filter aid. Without intending to be bound by theory, it is believed that the alkali silicate, e.g., sodium metasilicate, may provide a combination of base strength and moisture content particularly beneficial for neutralizing FFAs in an oil mixture.

The particulate composite material of the filter aid may comprise a silicate mineral at least partially or fully coated by one or more of silica, silicate, and/or aluminosilicate compounds. According to some aspects of the present disclosure, the silicate mineral comprises mineral particles comprising one or more silicate(s) and/or aluminosilicate(s), including glassy minerals and materials derived from glassy minerals. Exemplary silicates and aluminosilicates include, but are not limited to, diatomaceous earth, perlite, pumice, pumicite, volcanic ash, calcined kaolin, smectite, mica, shirasu, obsidian, pitchstone, rice hull ash, and combinations thereof.

Diatomaceous earth (also called “DE” or “diatomite”) is generally known as a sediment enriched in biogenic silica (silica produced or brought about by living organisms) in the form of siliceous frustules of diatoms. Diatoms are a diverse array of microscopic, single-celled, golden-brown algae generally of the class Bacillariophyceae that possess an ornate siliceous skeleton of varied and intricate structures including two valves that, in the living diatom, fit together much like a pill box. Diatomaceous earth may form from the remains of water-borne diatoms, and therefore, diatomaceous earth deposits may be found close to either current or former bodies of water. Those deposits are generally divided into two categories based on source: freshwater and saltwater. Freshwater diatomaceous earth is generally mined from dry lakebeds and may be characterized as having a low crystalline silica content and a high iron content. In contrast, saltwater diatomaceous earth is generally extracted from oceanic areas and may be characterized as having a high crystalline silica content and a low iron content.

Glassy minerals, which may also be referred to as “volcanic glasses,” are formed by the rapid cooling of siliceous magma or lava. Volcanic glasses, such as perlite and pumice, tend to occur in large deposits. Volcanic ash, often referred to as “tuff” when in consolidated form, includes small particles or fragments that may be in glassy form and also characterized as a glassy mineral.

Perlite is a hydrated glassy mineral that comprises silicon dioxide, aluminum oxide, and a combination of other metals or metal oxides, such as sodium oxide and iron oxide. For example, perlite may comprise about 70% to 75% SiO₂ by weight, about 12% to 15% Al₂O₃ by weight, about 0.5% to 2% Fe₂O₃ by weight, about 3% to 5% Na₂O by weight, about 3% to 5% K₂O by weight, about 0.4% to 1.5% CaO by weight, and lesser amounts of other metals or metal oxides. Perlite may be distinguished from other glassy minerals by a relatively higher water content (e.g., from about 2% to 5% by weight), a vitreous, pearly luster, and characteristic concentric or arcuate onion skin-like fractures. The Mohs hardness of perlite is typically greater than about 5, such as ranging from about 5.5 to about 7.0.

Expanded perlite refers to perlite that has been heated to cause thermal expansion through vaporization of its internal water. For example, perlite may be heated quickly to a point where the glass begins to soften (between about 750° C. and 1100° C.) and the water recombines and vaporizes. The water vapor can expand as long as the glass is soft enough to stretch with it, resulting in small bubbles in the glass matrix that can break and lead to smaller fragments with sharp edges.

Pumice is a glassy mineral characterized by a mesoporous structure, e.g., having pores or vesicles. The porous nature of pumice gives it a relatively low apparent density, in many cases allowing it to float on the surface of water. Pumice generally comprises from about 60% to about 70% SiO₂ by weight. Obsidian materials include glassy minerals that are rich in silica. Obsidian glasses may be classified into subcategories according to their silica content, with rhyolitic obsidians (containing typically about 73% SiO₂ by weight) being the most common. Rice hulls contain sufficient silica that they can be commercially ashed for their siliceous residue, a product commonly known as rice hull ash. Certain sponges are also concentrated sources of silica, the remnants of which may be found in geologic deposits as acicular spicules.

According to some aspects of the present disclosure, the silicate mineral comprises a silicate material, such as, e.g., biogenic silica. In some examples herein, the silicate mineral may comprise diatomaceous earth, perlite, pumice, pumicite, obsidian, pitchstone, volcanic ash, or a combination thereof. In some examples, the silicate mineral comprises diatomaceous earth. In at least one example, the silicate mineral comprises perlite, such as expanded perlite.

The silicate mineral may be treated, e.g., partially coated or fully coated, with one or more silica, silicate, and/or aluminosilicate compounds. In some examples, the coating comprises an inorganic silica and/or silicate. Exemplary inorganic silicas/silicates that may be used in the coating include, but are not limited to, silica gel, sodium silicate, magnesium silicate, and combinations thereof. In at least one example, the inorganic silica/silicate is precipitated onto surfaces of the silicate mineral. For example, the filter aids herein may comprise an inorganic silica/silicate or mixture of inorganic silicas/silicates precipitated onto particles (e.g., particles of diatomaceous earth, perlite, pumice, pumicite, obsidian, pitchstone, volcanic ash, or a combination thereof). In at least one example, the coated silicate mineral comprises diatomaceous earth particles at least partially coated or fully coated with sodium silicate, magnesium silicate, or a mixture of sodium silicate and magnesium silicate.

In at least one example, the composite material comprises silicate particles (e.g., diatomaceous earth particles) at least partially coated with magnesium silicate, and the alkali silicate comprises sodium silicate and/or potassium silicate. In at least one example, the composite material comprises silicate particles (e.g., diatomaceous earth particles) at least partially coated with sodium silicate, and the alkali silicate comprises a sodium silicate different than the sodium silicate of the coating. In yet another example, the composite material comprises silicate particles (e.g., diatomaceous earth particles) at least partially coated with silica gel, and the alkali silicate comprises a sodium silicate such as, e.g., sodium metasilicate.

In some examples, the silica/silicate coating may comprise from about 5% to about 50% by weight of the composite coated silicate mineral. For example, the filter aid may comprise a composite material comprising from about 20% to about 95% by weight mineral particles, and from about 5% to about 80% by weight of an inorganic silica/silicate at least partially or fully coating the mineral particles. In some examples, the composite material comprises from about 50% to about 95% by weight of biogenic silica (e.g., diatomaceous earth particles) or volcanic glass (e.g., perlite, pumice, pumicite, obsidian, pitchstone, or volcanic ash particles), and an inorganic silicate or mixture of inorganic silicates precipitated onto the biogenic silica or volcanic glass. In some examples, the composite material comprises from about 5% to about 80% by weight, from about 10% to about 70% by weight, from about 15% to about 50% by weight, or from about 25% to about 40% by weight of an inorganic silica/silicate or mixture of inorganic silicas/silicates with respect to the total weight of the composite material, wherein the inorganic silica/silicate or mixture of inorganic silicas/silicates at least partially coat or fully coat particles of biogenic silica or volcanic glass.

The mineral particles serving as substrates may undergo one or more processing steps, such as milling and/or classification, to provide a desired particle size distribution before coating. For example, the mineral particles may be milled such that the particles have a desired size distribution. Additionally or alternatively, the mineral particles may undergo one or more processing steps after coating. Particle sizes and other particle size properties referred to in the present disclosure may be measured by any appropriate measurement technique, such as, for example, a Sedigraph 5100 instrument, as supplied by Micromeritics Corporation, or a Microtrac Model X-100, as supplied by Leeds & Norththrup. Using such measuring devices, the size of a given particle is expressed in terms of the diameter of a sphere of equivalent diameter, sometimes referred to as equivalent spherical diameter or (ESD). The median particle size, or the d₅₀ value is the diameter at which 50% by weight of the particles have an ESD less than the d₅₀ value. Similarly, the d₉₀ value is the diameter at which 90% by weight of the particles have an ESD less than the d₉₀ value, and the d₁₀ value is the diameter at which 10% by weight of the particles have an ESD less than the d₁₀ value. Other methods and/or devices for determining particle sizes are contemplated.

According to some aspects of the present disclosure, the silicate mineral or composite material has a median particle diameter (d₅₀ value) ranging from about 1 μm to about 300 μm, such as from about 5 μm to about 300 μm, from about 100 μm to about 300 μm, from about 150 μm to about 300 μm, from about 1 μm to about 100 μm, from about 5 μm to about 100 μm, from about 10 μm to about 100 μm, from about 50μm to about 100 μm, from about 1 μm to about 50 μm, from about 5 μm to about 50 μm, from about 10 μm to about 50 μm, from about 1 μm to about 10 μm, from about 5 μm to about 10 μm, or from about 1 μm to about 5 μm. For example, the composite material may have a d₅₀ value ranging from about 40 μm to about 300 μm, from about 40 μm to about 250 μm, from about 100 μm to about 250 μm, from about 5 μm to about 150 μm, from about 40 μm to about 140 μm, from about 60 μm to about 120 μm, from about 30 μm to about 60 μm, from about 60 μm to about 90 μm, from about 90 μm to about 120 μm, from about 120 μm to about 150 μm, from about 1 μm to about 40 μm, from about 10 μm to about 40 μm, from about 10 μm to about 30 μm, or from about 15 μm to about 25 μm.

Additionally or alternatively, the silicate mineral or composite material may have a d₉₀ value ranging from about 50 μm to about 700 μm, such as, for example, from about 300 μm to about 700 μm, from about 300 μm to about 500 μm, from about 100 μm to about 300 μm, from about 200 μm to about 400 μm, from about 50 μm to about 300 μm, from about 100 μm to about 200 μm, from about 200 μm to about 300 μm, from about 50 μm to about 100 μm, from about 60 μm to about 140 μm, from about 70 μm to about 120 μm, or from about 80 μm to about 110 μm.

In addition or alternatively, the silicate mineral or composite material may have a d₁₀ value ranging from about 1 μm to about 30 μm, such as, for example, from about 1 μm to about 10 μm, from about 10 μm to about 20 μm, from about 20 μm to about 30 μm, from about 5 μm to about 15 μm, from about 15 μm to about 25 μm, from about 20 μm to about 25 μm, from about 2 μm to about 20 μm, from about 3 μm to about 15 μm, from about 4 μm to about 12 μm, from about 5 μm to about 10 μm, from about 1 μm to about 5 μm, or from about 1 μm to about 3 μm.

The silicate mineral or composite material may have a desired pore size or pore size distribution. One technique for describing pore size distributions in materials is mercury intrusion porosimetry, which uses mercury intrusion under applied isostatic pressure to measure micron-scale pores, such as those of the silicate mineral. In this method, a material is surrounded by liquid mercury in a closed evacuated vessel and the pressure is gradually increased, The vessel is sealed and the pressure is reduced to a very low level before mercury intrusion begins. At low pressures, the mercury will not intrude into the sample due to the high surface tension of liquid mercury. As the pressure is increased, the mercury is forced into the sample, but will first intrude into the largest spaces, where the curvature of the mercury surface will be the lowest. As pressure is further increased, the mercury is forced to intrude into tighter spaces of the material. Eventually all the voids will be filled with mercury, Nano-porous structure may be measured by nitrogen adsorption using an ASAP® 2460 Surface Area and Porosimetry Analyzer, available from Micromeritics Instrument Corporation (Norcross, Ga., USA). The plot of total void volume vs. pressure can thus be developed. The method can thus provide not only total pore volume, but also distinguish a distribution of pore sizes. Once a distribution of pores has been estimated, it is possible to calculate an estimation of surface area based on the pore sizes, and by assuming a pore shape (a spherical shape may be commonly assumed). Median pore size estimates can also be calculated based on volume or area. Median pore size (volume) is the pore size at 50^{th} percentile at the cumulative volume graph, while median pore size (area) is the 50^{th} percentile at the cumulative area graph. The average pore size (diameter) is four times the ratio of total pore volume to total pore area (4V/A). In some examples, the composite material may have a median pore diameter (4V/A) ranging from about 0.1 μm to about 10.0 μm, such as, for example, from about 0.1 μm to about 5.0 μm, from about 0.5 to about 5.0 μm, from about 0.1 μm to about 1.0 μm, from about 1.0 to about 10.0 μm, from about 1.0 μm to about 5.0 μm, from about 2.0 μm to about 5.0 μm, from about 1.5 μm to about 8.0 μm, or from about 5.0 μm to about 10.0 μm.

Filtration components with lower wet densities may result in products with greater porosity, and thus perhaps greater filtration efficiency, provided that the true density stays relatively constant. According to some aspects, the composite material may have a wet density ranging from about 5 lbs/ft³ to about 30 lbs/ft³ (corresponding to a range of about 80.1 kg/m³ to about 480.6 kg/m³). For example, the composite material may have a wet density in a range from about 10 lbs/ft³ to about 20 lbs/ft³, from about 20 lbs/ft³ to about 30 lbs/ft³, from about 15 lbs/ft³ to about 25 lbs/ft³, from about 25 lbs/ft³ to about 35 lbs/ft³, from about 15 lbs/ft³ to about 20 lbs/ft³, from about 20 lbs/ft³ to about 25 lbs/ft³, or from about 25 lbs/ft³ to about 30 lbs/ft³. Because wet density reflects the void volume of the adsorbent component to entertain matter in the filtration process, a lower wet density may indicate that the adsorbent component has a high void volume and thus can adsorb more constituents in the fluid.

Wet density may be measured by placing a sample of known weight (from about 1.00 g to about 2.00 g) in a calibrated 15 mL centrifuge tube. Deionized water is then added to make up a volume of approximately 10 mL. The mixture is shaken thoroughly until all of the sample is wetted, and no powder remains. Additional deionized water is added around the top of the centrifuge tube to rinse down any mixture adhering to the side of the tube from shaking. The tube is then centrifuged for 5 minutes at 2500 RPM on an IEC Centra® MP-4R centrifuge, equipped with a Model 221 swinging bucket rotor (International Equipment Company; Needham Heights, Mass., USA). Following centrifugation, the tube is carefully removed without disturbing the solids, and the level (volume) of the settled matter is measured. The centrifuged wet density is then calculated by dividing the sample weight by the measured volume, e.g., units of g/cm³ (or kg/m³ or lbs/ft³, etc., based on the units used during the test).

The filter aids herein may have characteristics beneficial for filtration of oils and oil mixtures. According to some examples herein, the filter aid has a BET surface area (i.e., specific surface area calculated according to the Brunauer, Emmett, and Teller (BET) theory) ranging from about 0.2 m²/g to about 450 m²/g, such as from about 5 m²/g to about 400 m²/g, from about 25 m²/g to about 250 m²/g, from about 50 m²/g to about 150 m²/g, from about 100 m²/g to about 200 m²/g, from about 75 m²/g to about 150 m²/g, from about 300 m²/g to about 450 m²/g, from about 250 m²/g to about 300 m²/g, from about 100 m²/g to about 150 m²/g, or from about 50 m²/g to about 300 m²/g.

According to some examples, the filter aid may have a permeability suitable for use in filtering non-aqueous liquids, such as, for example edible oils or other oils or oil mixtures used or useful in cooking. Permeability is generally measured in darcy units or darcies. Permeability may be determined using a device designed to form a filter cake on a septum from a suspension of filter aid composition in water, and then measuring the time required for a specified volume of water to flow through a measured thickness of filter cake of known cross-sectional area. For example, the permeability may be measured through a porous of filter aid material 1 cm high and with a 1 cm² section through which flows a fluid with a viscosity of 1 mPa·s with a flow rate of 1 cm³/sec under an applied pressure differential of 1 atmosphere. The principles for measuring permeability have been previously derived for porous media from Darcy's law (see, for example, J. Bear, “The Equation of Motion of a Homogeneous Fluid: Derivations of Darcy's Law,” in Dynamics of FLuids in Porous Media 161-177 (2nd ed. 1988)).

According to some examples, the filter aid may have a permeability ranging from about 0.05 darcy to about 10.0 darcy. For example, the filter aid may have a permeability ranging from about 0.1 darcy to about 10.0 darcy, from about 0.1 darcy to about 5.0 darcy, from about 0.1 darcy to about 3.0 darcy, from about 0.5 darcy to about 2.5 darcy, from about 0.5 darcy to about 1.5 darcy, from about 1.0 darcy to about 2.0 darcy, from about 0.1 darcy to about 1.0 darcy, from about 0.5 darcy to about 1.0 darcy, from about 1.0 darcy to about 2.5 darcy, from about 0.05 darcy to about 1.0 darcy, or from about 0.1 darcy to about 0.5 darcy.

According to some aspects of the present disclosure, the filter aid may be provided as a composition, such as an aqueous suspension or slurry. In some examples, the composition may comprise water, e.g., at least 75% by weight or at least 80% by weight water, and from about 1.0% by weight to about 10.0% by weight of the filter aid. For example, the composition may comprise from about 1.0% by weight to about 5.0% by weight, from about 2.5% by weight to about 7.5% by weight, from about 5.0% by weight to about 7.5% by weight, from about 3.5% by weight to about 8.0% by weight, or from about 3.5% by weight to about 6.5% by weight of the filter aid, with respect to the total weight of the composition. According to some aspects, the composition comprises an aqueous suspension or slurry that comprises 4.0% by weight, 4.5% by weight, 5.0% by weight, 5.5% by weight, or 6.0% by weight of the filter aid, with respect to the total weight of the composition. Such aqueous compositions may have a pH ranging from about 9.0 to about 13.0, such as from about 10.0 to about 13.0, from about 11.0 to about 12.0, or from about 12.0 to about 13.0.

The filter aids herein may be prepared, for example, by preparing a composite material (particulate material) by at least partially coating a silicate mineral with an inorganic silica/silicate (e.g., silicate salt or silica gel), and combing the composite material with an alkali silicate, e.g., sodium metasilicate.

Preparing the composite material of the filter aid may comprise precipitating the inorganic silicate onto a surface of the silicate mineral, such as precipitating sodium silicate and/or magnesium silicate onto particles of diatomaceous earth, perlite, pumice, pumicite, obsidian, pitchstone, volcanic ash, or a combination thereof. The precipitated sodium and/or magnesium silicate may form an adsorbent coating or layer that has been precipitated in-situ on the surface of the substrate mineral particles. In some examples, the silicate mineral particles may be coated with a silica gel, e.g., by combining the silicate mineral particles with water, sodium silicate, and an acid (e.g., H₂SO₄). The composite material thus formed may retain adsorptive characteristics of the silicate coating (e.g., for formation of FFA salts) and filtration properties of the substrate mineral particles.

In one example, the filter aid can include a an alkali silicate coated silicate mineral, such as for example a sodium silicate-coated diatomite or a sodium silicate coated perlite. In one example, the filter aid comprises an alkali silicate, and a silicate mineral, wherein at least a portion of the alkali silicate is present as a coating on the silicate mineral, and wherein the ratio of said alkali silicate to silicate mineral in the filter aid ranges from about 1:4 to 4:1 by weight.

In some examples, the alkali silicate can for example comprise a sodium silicate, a potassium silicate, or a mixture thereof. For example, the alkali silicate can comprise a sodium metasilicate, such as for example sodium metasilicate pentahydrate, sodium metasilicate nonahydrate, anhydrous sodium metasilicate, or a mixture thereof. In some examples, the silicate mineral can comprise a biogenic silica (e.g., diatomite), a perlite, a pumice, a pumicite, an obsidian, a pitchstone, a volcanic ash, or a combination thereof.

In some examples, the ratio of alkali silicate in the coating to silicate mineral can range from about 1:4 to about 4:1, for example from about 1:2 to about 1:4, from about 3:4 to about 1:4, from about 1:1 to about 1:4, from about 1:1 to about 1:3, from about 1:1 to about 1:2, or from about 1:2 to about 2:1.

In one example, the coating can be accomplished using a rotary mixer, a pan pelletizer. In another example the coating can be accomplished using a spray drying process, In some examples, the method of making a filter aid can include mixing an adsorbent with the alkali silicate and silicate mineral. Generally it is thought that mixing based peiletization methods are favored at lower ratios of alkali silicate in the coating to silicate mineral, and spray drying is favored at higher ratios.

In another example, the filter aid can include a combination of an alkali silicate, a silicate mineral, and an adsorbent material. In this example, the silicate mineral filter need not be chemically modified or functionally coated. When the alkali silicate and silicate mineral are used in conjunction with adsorbent, the resulting filter aid cab provide a good balance of free fatty acid removal, soap removal, filtration rate and cost, even if the adsorbent itself has a relatively low filtration efficiency.

In one example, the adsorbent can be at least partially coated onto the silicate mineral. In other examples, the adsorbent can be a particulate material substantially unbound from the silicate mineral. In some examples, the adsorbent can comprise an alkaline earth metal silicate, such as for example a magnesium silicate.

In some examples, the filter aid comprises from about 10% to about 60% by weight alkali silicate, about 10% to about 60% by weight silicate mineral, and about 10% to about 60% by weight adsorbent. For example, the filter aid can comprise from 10% to about 50% by weight alkali silicate, such as for example about 20% to about 50%, from about 30% to about 60%, or from about 30% to about 50%. Also for example, the filter aid can comprise from 10% to about 50% by weight silicate mineral, such as for example about 20% to about 50%, from about 30% to about 60%, or from about 30% to about 50%. In another example, the filter aid can comprise from 10% to about 50% by weight adsorbent, such as for example about 10% to about 40%, from about 20% to about 50%, or from about 20% to about 40%.

In some exemplary methods herein, the silicate mineral particles may be mixed with water to form a suspension or slurry. A sodium silicate solution, potassium silicate solution, and/or magnesium sulfate solution (when the coating comprises magnesium silicate) may be added to the suspension and the mixture may be stirred or agitated to precipitate the silicate. The sodium silicate may comprise, for example, sodium orthosilicate (Na₄SiO₄), sodium metasilicate (Na₂SiO₃), and/or sodium disilicate (Na₂Si₂O₅). The magnesium sulfate may be any magnesium sulfate that reacts with the sodium silicate to precipitate magnesium silicate. For example, the magnesium sulfate may be an aqueous magnesium sulfate, which may be diluted before being combined with sodium silicate solution to achieve a desired molarity for precipitation.

According to some aspects of the present disclosure, the composite material may be treated with an acid before combining the material with the alkali silicate to form the filter aid. Without wishing to be bound by a particular theory, it is believed that the acid treatment reacts with a surface of the silicate coating to improve the adsorption and/or impurity removal properties of the composite material. According to some examples, the acid treatment may alter the surface chemistry of the composite material. For example, the acid treatment may lower the surface pH of the silicate coating, which may facilitate adsorption of impurities, such as metals, soaps, and FFAs, from non-aqueous liquids such as oils and oil mixtures.

For example, the composite material may be treated with at least one mild acid, such as, for example, citric acid, acetic acid, oxalic acid, malic acid, tartaric acid, ascorbic acid, or mixtures thereof. The acid treatment may be performed by mixing the coated silicate mineral particles with the acid or with a mixture of acid and water. According to some aspects, the acid treatment may include spraying the acid or the mixture of acid and water onto the material. In some examples herein, the acid-treated composite material may then be dried, optionally at an elevated temperature, e.g., a temperature greater than about 70° C., or ranging from about 70° C. to about 120° C., before combining the composite material with the alkali silicate, e.g., sodium metasilicate.

In some examples, the composite material is not treated with an acid before combining the material with the alkali silicate to form the filter aid.

According to some aspects of the present disclosure, the filter aid may comprise from about 0.5% to about 20% by weight water moisture, such as, e.g., from about 5% to about 20%, from about 5% to about 15%, from about 10% to about 20%, from about 0.5% to about 10%, from about 2% to about 8%. from about 5% to about 10%, from about 1% to about 5%, from about 6% to about 9%, from about 2.5% to about 4.5%, or from about 3% to about 5% by weight water. For example, the method of preparing the filter aid may comprise preparing a material by at least partially coating a silicate mineral with an inorganic silica or silicate; combining the composite material with an alkali silicate; and adding from about 1% to about 10% by weight water. Without intending to be bound by theory, it is believed that the addition of water moisture may improve the filtration performance of the filter aid, e.g., via the formation of FFA salts with the alkali silicate and subsequent adsorption of the FFA salts to the composite material.

The filter aids herein may be used for filtering various non-aqueous liquids. For example, the liquid may be an oil or oil mixture, e.g., comprising an edible oil, such as an oil derived from animal or plant material useful for cooking. Suitable oils may include palm oil, palm kernel oil, butter, ghee, cocoa butter, cocoa butter substitutes, illipe fat, shea fat, canola oil, castor oil, coconut oil, coriander oil, corn oil, cottonseed oil, hazelnut oil, hempseed oil, linseed oil, mango kernel oil, olive oil, peanut oil, rapeseed oil, rice bran oil, safflower oil, soybean oil, sunflower oil, animal fat or oil (e.g., duck fat, lard, tallow, fish oil), and mixtures thereof. The oil may have been subjected to one or more refining steps including degumming, bleaching, deodorizing and/or interesterification, such as, for example, by chemical or enzymatic treatment, prior to being filtered. In at least one example, the oil is refined. The oil may additionally have undergone other treatment steps such as fractionation, prior to being filtered.

In some examples, the oil comprises one or more oils derived from palm. Oils derived from palm include palm oil, palm oil stearin, palm oil olein, palm kernel oil, palm kernel stearin and palm kernel olein, and interesterified products thereof. In some examples, the vegetable oil comprises palm oil or a fraction thereof. Palm oil fractions include palm oil oleins, palm oil stearins, palm mid-fractions and interesterified products thereof. The vegetable oil may include refined palm oil or a fraction thereof, such as palm oil olein or palm oil stearin.

According to some aspects of the present disclosure, the oil comprises a cooking oil, such as a frying oil, which may include one or more of the exemplary oils and fats listed above. The oil may be filtered according to the present disclosure before use in cooking and/or after use in cooking (e.g., wherein the oil to be filtered comprises a used cooking oil). For example, the filter aids herein may be used to filter used cooking oil, e.g., to improve the quality of the oil for use in subsequent cooking (e.g., frying) processes. The oil to be filtered may comprise FFAs and/or other components generally considered to be contaminants to be removed.

According to some aspects of the present disclosure, the method may include passing a liquid through, or otherwise contacting a liquid with, a filter aid as disclosed herein. In some examples, the filter aid may be added directly to the liquid to be filtered, generally known as body feeding. In an exemplary filtration process, an oil comprising FFAs may be combined with a composite filter as disclosed herein to form a mixture. The oil may comprise at least 0.05% by weight FFAs, e.g., from about 0.05% to about 10.0% by weight, from about 0.1% to about 8.0% by weight, from about 0.5% to about 5.0% by weight, from about 1.0% to about 5.0% by weight, from about 5.0% to about 10.0% by weight, from about 7.0% to about 9.0% by weight, from about 4.0% to about 6.0% by weight, from about 1.0% to about 3.0% by weight, from about 1.5% to about 2.5% by weight, from about 0.05% to about 2.0% by weight, or from about 0.1% to about 3.0% by weight FFAs. For example, the oil may contain about 0.5%, about 0.7%, about 1.0%, about 1.2%, about 1.4%, about 1.6%, about 1.8%, about 2,0%, about 2.2%, about 2_4%, or about 2.5% by weight FFAs.

The mixture of oil and filter aid may comprise from about 0.05% to about 10.0% by weight of the filter aid relative to the weight of the oil. In some examples, the filter aid may be combined with the oil in dry form, e.g., as a particulate filter aid. in other examples, the filter aid may be prepared as an aqueous suspension, e.g., in an amount ranging from about 1.0% by weight to about 10.0% by weight of the filter aid, relative to the total weight of the aqueous suspension.

The oil may be agitated, e g., to adequately distribute the filter aid throughout the oil. In some examples, the oil (or oil/aqueous mixture) may be heated, e.g., at or to a temperature ranging from about 50° C. to about 130° C. or from about 60° C. to about 120° C., e.g., a temperature of about 70° C., about 80° C. about 90° C., about 100° C., or about 110° C. In some embodiments, the oil can be at a temperature as high as 120° C.-160° C. After a period of time sufficient for filtration of the liquid, the particles may be collected and removed from the liquid. For example, upon formation of FFA salts and adsorption of the FFA salts to the composite material, the material may be removed from the oil, thus removing the FFAs from the oil. The material may be removed by any suitable technique, such as, e.g., filtration, centrifugation, etc.

In some cases, the method of filtration may include pre-coating at least one filter element with the filter aid, and contacting the liquid to be filtered with the at least one filter element(s). The filter element(s) may comprise a septum (e.g., mesh screen, membrane, or pad), a cylindrical tube or wafer-like structure covered with a plastic, or metal fabric of sufficiently fine weave. In certain cases, the filter element(s) may comprise a porous structure with a void to allow material of a certain size to pass through a filtration device. The filter aid may initially be applied to a septum of a filter element in a process known as pre-coating. Pre-coating may generally involve mixing a slurry of water and the filter aid, and introducing the slurry into a stream flowing through the septum. During this process, a thin layer, such as, for example, about 1.5 mm to about 3.0 mm, of filter aid may be deposited on the septum, thus forming the filtration device.

The filter aids herein may be capable of removing at least a portion, or substantially all, the FFAs of an oil. For example, the filter aids herein may be used to remove at least 50%, at least 60%, at least 70%, at least 80%, at least 90%, at least 95%, or at least 99% of the FFAs of an oil. In some examples, the filter aid removes from about 40% to about 99% of the FFAs from the oil, such as from about 50% to about 95%, from about 60% to about 90%, from about 75% to about 99%, from about 80% to about 95%, or from about 90% to about 99% FFA removal. Additionally or alternatively, the methods herein may remove at least 50% of the soap (e.g., FFA salts produced from FFAs) of an oil, such as at least 60%, at least 70%, at least 80%, at least 90%, at least 95%, or at least 99% soap removal. In some examples, the filter aids may remove from about 75% to about 99%, from about 80% to about 99%, from about 90% to about 99%, or from about 95% to about 99% of the soap (produced from FFAs) of an oil. In some examples, the filter aids may remove substantially all soap from an oil (greater than 99% soap removal).

In one aspect, an alkali carbonate or bicarbonate can optionally be added to the oil prior to or during filtration to provide enhanced removal of free-fatty acids. In one aspect, the alkali carbonate or bicarbonate can be added and filtration performed at an elevated temperature, such as for example greater that about 120° C., greater than about 130° C. or greater than about 140′C. In one aspect, the elevated temperature can result from residual heat from the operating temperature of frying oil, thereby reducing the need for cooling prior to free-fatty acid removal treatment. Thus, a formulation with good performance at elevated temperature can have better utility for users.

Aspects of the present disclosure are further illustrated by reference to the following, non-limiting numbered exemplary embodiments.

1. A filter aid comprising: (a) an alkali silicate, and (b) a composite material comprising a silicate mineral at least partially coated with an inorganic silica or silicate.

2. A filter aid comprising: (a) an alkali silicate, and (b) a silicate mineral, wherein at least a portion of the alkali silicate is present as a coating on the silicate mineral, and wherein the ratio of said alkali silicate to silicate mineral in the filter aid ranges from about 1:4 to 4:1 by weight.

3. A filter aid comprising an alkali silicate, a silicate mineral, and an adsorbent.

4. The filter aid of paragraph 1, wherein the alkali silicate comprises from about 10 to about 70% by weight of the filter aid.

5. The filter aid of paragraph 3, comprising about 10% to about 60% by weight alkali silicate, about 10% to about 60% by weight silicate mineral, and about 10 to about 60% by weight adsorbent.

6. The filter aid of paragraph 3, wherein said adsorbent is at least partially coated onto the silicate mineral.

7. The filter aid of paragraph 3, wherein the adsorbent is a particulate material substantially unbound from the silicate mineral.

8. The filter aid according to any preceding paragraph, wherein the alkali silicate comprises a sodium silicate, a potassium silicate, or a mixture thereof.

9. The filter aid according to any preceding paragraph, wherein the alkali silicate comprises sodium metasilicate,

10, The filter aid according to any preceding paragraph, wherein the sodium metasilicate is sodium metasilicate pentahydrate, sodium metasilicate nonahydrate, anhydrous sodium metasilicate, or a mixture thereof.

11. The filter aid according to any preceding paragraph, wherein the alkali silicate comprises sodium metasilicate pentahydrate.

12. The filter aid according to any preceding paragraph, wherein the silicate mineral comprises biogenic silica.

13. The filteraid according o any preceding paragraph, wherein the silicate mineral comprises diatomaceous earth.

14. The filter aid according to any preceding paragraph, wherein the silicate mineral comprises perlite, pumice, pumicite, obsidian, pitchstone, volcanic ash, or a combination thereof.

15. The filter aid of any of paragraphs 3 to 7, wherein said adsorbent is a magnesium silicate.

16. The filter aid according to paragraph 1, wherein the inorganic silica or silicate comprises silica gel, sodium silicate, magnesium silicate, or a combination thereof.

17, The filter aid according to paragraph 1, wherein the inorganic silica or silicate is precipitated onto a surface of the silicate mineral.

18. The filter aid according to paragraph 1, wherein the composite material comprises from about 50% to about 95% by weight of biogenic silica.

19. The filter aid according to paragraph 1, wherein the composite material comprises from about 5% to about 80% by weight of the inorganic silica or silicate with respect to the total weight of the composite material.

20, The filter aid according to any preceding paragraph, wherein the filter aid has a permeability ranging from about 0.05 darcy to about 3.0 darcy

21. The filter aid according to any preceding paragraph, wherein the filter aid has a BET surface area ranging from about 5 m²/g to about 450 m²/g.

22. The filter aid according to paragraph 1, wherein a particle size distribution of the composite material has a d50 diameter ranging from about 5 μm to about 300 μm,

23. The filter aid according to paragraph 1, wherein the composite material has a median pore diameter (4V/A) ranging from about 0.1 μm to about 10.0 μm.

24. The filter aid according to paragraph 1, wherein the composite material has a wet density ranging from about 5 lb/ft³ to about 30 lb/ft³.

25. The filter aid according to any preceding paragraph, wherein the filter aid comprises from about 0.5% to about 20% by weight water, with respect to the total weight of the filter aid, such as for example from about 1% to about 10% by weight water.

26. A composition comprising the filter aid according to any preceding paragraph.

27. The composition according to paragraph 26, wherein the composition comprises at least 80% by weight filter aid and from about 1.0% by weight to about 10.0% by weight water, with respect to the total weight of the composition.

28. The composition according to paragraph 26 or 27, wherein the composition has a pH ranging from about 9.0 to about 13.0.

29. Use of the filter aid according to any of paragraphs 1-25 or the composition of any of paragraphs 26-28 for filtering an oil.

30. A method of filtering an oil, the method comprising combining the oil with the filter aid according to any of paragraphs 1-25 to form a mixture.

31. The method according to paragraph 30, further comprising heating the mixture.

32. The method according to paragraph 30 or 31, wherein the oil comprises from about 0.05% to about 10.0% by weight free fatty acids.

33. The method according to any of paragraphs 30-31, further comprising separating at least a portion of the filter aid from the oil, wherein the filter aid removes at least 50%, at least 65%, or at least 70% by weight of the free fatty acids from the oil.

34. The method according to any of paragraphs 30-33, wherein the oil comprises an edible oil.

35. The method according to any of paragraphs 30-34, wherein the mixture comprises from about 0.05% to about 10.0% of the filter aid relative to the weight of the oil.

36. A method of making the filter aid according to any of paragraphs 1, 4, 8-14, and 16-25.

37. The method according to paragraph 36, wherein the method comprises preparing a composite material by at least partially coating a silicate mineral with an inorganic silica or silicate; and combining the composite material with an alkali silicate.

38. The method according to paragraph 36 or 37, wherein the silicate mineral comprises diatomaceous earth, and preparing the composite material comprises precipitating the inorganic silica or silicate onto a surface of the diatomaceous earth.

39. The method according to any of paragraphs 36-38, further comprising adding water to the filter aid, such that the filter aid comprises from about 0.5% to about 10% by weight water, with respect to the total weight of the filter aid.

The following examples are intended to illustrate the present disclosure without, however, being limiting in nature. It is understood that the present disclosure encompasses additional embodiments consistent with the foregoing description and following examples.

### EXAMPLES

### Example 1

Experiments were performed to compare the performance of different filter aid compositions in filtering oil samples with high FFA content. The oil sample used in each case was a commercially-available vegetable oil for home cooking use (comprising <0.1% wt. FFA) spiked with 2% wt. oleic acid to simulate FFA contamination.

Four compositions were tested as summarized in Table 1 below. Samples 1 and 2 were prepared according to the present disclosure as filter aids comprising sodium metasilicate pentahydrate and either magnesium silicate-coated diatomaceous earth particles or silica gel-coated diatomaceous earth particles having a particle size wherein greater than 95% of the particles are below 400 μm in size and greater than 95% of the particles are above 5 μm in size. Sample 1 was prepared with 30% wt. Na₂SiO₃.5H₂O and 70% wt. DE/MgO—SiO₂ composite (comprising 60% wt. MgO—SiO₂ (having a SiO₂/MgO molar ratio ranging from about 2.5 to about 3.2) coated on 40% wt. DE particles) (Imerys). Sample 2 was prepared with 30% wt. Na₂SiO₃.5H₂O and 70% wt. DE/SiO₂ composite (comprising 60% wt. silica gel coated on 40% wt. DE particles) (Imerys). Two reference samples (Samples 3 and 4) were also prepared from MAGNESOL® 600R and MAGNESOL® PolySorb 30/40, which are products commercially available from the Dallas Group. Sample 3 was DALSORB® (comprising 60% wt. Na₂SiO₃ and 40% wt. MgSiO₃), and Sample 4 was a 50/50 mixture of MAGNESOLO 600R and MAGNESOL® PolySorb 30/40 (comprising 30% wt. Na₂SiO₃ and 70% wt. MgSiO₃).

In each case, 150 grams of the oil was heated to 100° C., and a 3-gram sample of the dry composition (2% by weight of the oil) was added. The mixture was stirred for 60 minutes at 100° C. The treated oil was then vacuum filtered through a heated Buchner funnel (100±5° C.) with Whatman #4 filter paper. The time required to filter the 150-gram oil sample was recorded to ±1 minute precision.

The filtered oil samples were titrated for FFA content with NaOH in isopropanol, using phenolphthalein as the indicator (AOCS Official Method Aa 6-38). The percent FFA removal was calculated according to Eq. 3:

$$\% FFA removal = \frac{FFA titrated in treated sample}{FFa titrated in untreated oil sample} \qquad Eq . 3$$

To determine soap removal, the filtered oil samples were titrated for soap content with HCl in acetone with 2% water, using bromophenol blue as the indicator (AOCS Recommended Practice Cc 17-95). The percent soap removal was calculated according to Eq. 4:

$$\% soap removal = \frac{soap titrated in treated sample}{theoretical soap generated} \qquad Eq . 4$$

The amount of theoretical soap generated was calculated according to Eq. 5:

$$theoretical soap generated = \frac{304.4}{282.5} FFA titrated in treated sample \qquad Eq . 5$$

Results are shown in Table 1 below,

TABLE 1

| | | Filtration | FFA | Soap |
|---|---|---|---|---|
| Composition | Formulation | (min) | removal | removal |
| Sample 1 | 30% wt. Na₂SiO₃•5H₂O + | 10 | 73% | 99% |
| | 70% wt. DE/MgSiO₃ Composite | | | |
| Sample 2 | 30% wt. Na₂SiO₃•5H₂O + | 10 | 70% | 99% |
| | 70% wt. DE/SiO₂ Composite | | | |
| Sample 3 | MAGNESOL ® 600R | 40 | 62% | 99% |
| (ref) | | | | |
| Sample 4 | 50% MAGNESOL ® 600R + | 25 | 53% | 85% |
| (ref) | 50% MAGNESOL ® PolySorb 30/40 | | | |
| | (30% wt. Na₂SiO₃ + 70% wt. MgSiO₃) | | | |

Samples 1 and 2 were found to provide higher FFA removal, equivalent or higher soap (derived from FFA) removal, and faster filtration times as compared to the commercially-available products.

### Example 2

Using the same procedure described in Example 1, additional filter aid compositions (Samples 5, 6, and 9-14) and reference compositions (7 and 8) were prepared and tested for filtration time. % FFA removal, and % soap removal, as summarized in Table 2. For these studies, two different types of composite magnesium silicate-coated DE particles were used, comprising 60% wt. MgO—SiO₂ (having a SiO₂/MgO molar ratio ranging from about 2.5 to about 3.2) coated on 40% wt. DE particles (samples 5, 6, 9, and 11) (Irnerys) or 40% wt. MgO—SiO₂ (having a SiO₂/MgO molar ratio ranging from about 2.5 to about 3.2) coated on 60% wt. DE particles (samples 10 and 13) (Imerys). Silica gel-coated DE particles was used for samples 12 and 14 (lmerys). Anhydrous sodium silicate (molar ratio SiO₂/Na₂O=2.0) and BRITESIL® C20 sodium silicate (molar ratio SiO₂/Na₂O=2,0: 17.5% moisture) were obtained from PQ Corporation. Water was added to sample 6, providing for about 8% by weight water moisture.

TABLE 2

| | | Filtration | FFA | Soap |
|---|---|---|---|---|
| Composition | Formulation | (min) | removal | removal |
| Sample 5 | 50% wt. BRITESIL ® C20 + | 5 | 48% | 94% |
| | 50% wt. DE/MgO—SiO₂* Composite | | | |
| Sample 6 | 30% wt. anhydrous Na₂O—SiO₂ + | 10 | 45% | 92% |
| | 62% wt. DE/MgO—SiO₂* Composite + 8% water | | | |
| Sample 7 | 30% BRITESIL ® C20 + | 20 | 38% | 79% |
| (ref) | 70% wt. MAGNESOL ® PolySorb 30/40 | | | |
| Sample 8 | 30% wt. anhydrous Na₂OSiO₂ + | 5 | 38% | 81% |
| (ref) | 70% wt. MAGNESOL ® PolySorb 30/40 | | | |
| Sample 9 | 30% wt. BRITESIL ® C20 and | 5 | 33% | 84% |
| | 70% DE/MgO—SiO₂* Composite | | | |
| Sample 10 | 30% wt. BRITESIL ® C20 and | 10 | 30% | 86% |
| | 70% DE/MgO—SiO₂† Composite | | | |
| Sample 11 | 30% wt. anhydrous Na₂O-SiO₂ and | 5 | 28% | 80% |
| | 70% DE/MgSiO₂* Composite | | | |
| Sample 12 | 30% wt. BRITESIL ® C20 and | 5 | 26% | 87% |
| | 70% DE/SiO₂^{§} Composite | | | |
| Sample 13 | 30% wt. anhydrous Na₂O—SiO₂ + | 10 | 24% | 80% |
| | 70% wt. DE/MgO—SiO₂† Composite | | | |
| Sample 14 | 30% wt, anhydrous Na₂O—SiO₂ + | 5 | 14% | 62% |
| | 70% DE/SiO₂^{§} Composite | | | |

^{§}DE/SiO₂ = 40% wt. silica gel coated on 60% wt. DE particles
*DE/MgO—SiO₂ = 60% wt. MgO—SiO₂ coated on 40% wt. DE particles
^{†}DE/MgO—SiO₂ = 40% wt. MgO—SiO₂ coated on 60% wt. DE particles

These studies, as compared to Example 1, suggest that various alkali silicates other than sodium metasilicate successfully removed FFAs from oil, Compositions comprising sodium silicate with higher SiO₂/Na₂O molar ratios were found to generally result in lower FFA removal, The compositions with silicate-coated diatomaceous earth particles also resulted in higher FFA removal as compared to silica gel-coated particles. Further, the results for composition F suggest that loading some additional water to the filter aid may lead to better performance in filtration of FFAs.

### Example 3

Samples of alkali silicate coated silicate minerals were assayed using the same general procedure described in Example 1, except the oil used had a free-fatty acid content of about 0.82%. Samples of filter aid comprising sodium silicate coated diatomite were prepared as follows: 1600 g sodium silicate (Oxy Chemicals Grade 50), 560 g diatomite, and 384 g deionized water were mixed. The resulting mixture was spray dried in a lab scale spray dryer with an inlet temperature set of 320° C. and outlet temperature of 108° C., and a pumping feed rate set at 21 rpm.

The resulting spray dried material is considered a sodium silicate coated DE (NaSil-DE), with NaSil:DE ratio of 1.5:1 (w/w), and about 15% moisture in the sodium silicate coating (total moisture approximately 10%, determined by drying loss at 400° C.). BRITESIL® C20 silica gel was used as a control in Samples 18-20. In sample 20, 50% BRITESIL® C20 was mixed with 50% high-purity grade silica gel having a pore size 60 Å, 230-400 mesh particle size, and a 550 m²/g BET surface area (commercially available from Sigma-Aldrich).

TABLE 3

| | | Filtration | | Soap |
|---|---|---|---|---|
| | | Time | % FFA | Residue |
| | Treatment Formulation | (min) | Removal | (ppm) |
| Sample 15 | 100% NaSil-DE | <5 | 85 | 205 |
| Invention | | | | |
| Sample 16 | 80% NaSil-DE + 20% Na₂SiO3•5H₂O | 20 | 96 | 161 |
| Invention | | | | |
| Sample 17 | 80% NaSil-DE + 20% DE/SiO2 | <5 | 81 | 115 |
| Invention | | | | |
| Sample 18 | 80% BRITESIL ® C20 + 20% DE/SiO2 | <5 | 70 | 160 |
| Competitor | | | | |
| Sample 19 | 50% BRITESIL ® C20 + 50% DE/SiO2 | <5 | 49 | 109 |
| Competitor | | | | |
| Sample 20 | 80% BRITESIL ® C20 + 20% silica gel | <5 | 70 | 245 |
| Competitor | | | | |

As shown in Table 3 above, the composite material “NaSil-DE”, when used alone (Sample 15), achieved very good filtration time and FFA removal, and satisfactory soap removal performance. The combination with 80% NaSil-DE with 20% DE/SiO₂ composite (Sample 17) allowed excellent soap removal, and is typically considered the best balance among three performance factors. The combination of 80% NaSil-DE with 20% sodium metasilicate pentahydrate (Na2SiO3.5H2O) (Sample 16) allowed nearly complete removal of FFA.

### Example 4

Samples were assayed as set forth in Table 4 below using the same general procedure described in Example 1 , except the oil used had a free-fatty acid content of about 0.82%, to assess the effect of use of adsorbent magnesium silicate. The magnesium silicate used (MgSil) was a precipitated magnesium silicate Commercially available from Shangyu Jiehua (Particle size Dv=60 μm, Dn=9.3 μm, ˜500 m²/g BET surface area).

TABLE 4

| | | | | | Soap |
|---|---|---|---|---|---|
| | | Temp. | Clogging | % FFA | Residue |
| | Treatment Formulation | (° C.) | of Filter? | Removal | (ppm) |
| Sample 21 | 40% Sodium Metasilicate + | 85 | N | 83 | 79 |
| Invention | 20% Milled Expanded Perlite + 40% MgSil | | | | |
| Sample 22 | 40% Sodium Metasilicate + | 85 | N | 80 | 92 |
| Invention | 30% Flux Calcined Diatomite + 30% MgSil | | | | |
| Sample 23 | 40% Sodium Metasilicate + | 85 | N | 71 | 144 |
| Invention | 60% Milled Expanded Perlite | | | | |
| Sample 24 | 40% Sodium Metasilicate + 60% MgSil | 85 | Y | 87^{‡} | 42^{‡} |
| Comparative | | | | | |

^{‡}Based on oil recovered before filter clogging.

The combination of sodium metailicate and expanded milled perlite (sample 23), achieved very good FFA removal and soap removal performance, However, the composite materials with magnesium silicate and mineral filter aids (Samples 21 and 22), achieved even better FFA removal and soap removal performance. A mixture of 40% sodium metasilicate and 60% MgSil was tested and found to result in clogging of the filter, likely due to the failure to effectively filter the soaps. Samples 21-23 completed filtration within 3 minutes, which correlates to good filtration rates for practical use.

### Example 5

Inclusion of sodium carbonate (e) or sodium bicarbonate (e) in the filter aid formulations was found to have little effect in FFA reduction at low temperatures. Specifically, vegetable oil containing 2% oleic acid (150 g) treated for 60 minutes using a 2 formulation (3 g) containing 40% NaHCO₃+60% (DE-SiO₂), or 40% Na₂CO₃+60% (DE-SiO₂) composite, resulted in approximately 10% relative removal of FFA (or 0.2% absolute reduction of FFA). However, when the temperature was increased to 146° C. (290° F.) FFA reduction was increased to 71% (or 0.85% absolute reduction of FFA).

Other aspects and embodiments of the present disclosure will be apparent to those skilled in the art from consideration of the specification and practice of the embodiments disclosed herein.

It is intended that the specification and examples therein be considered as exemplary only, with a true scope and spirit of the present disclosure being indicated by the following claims.

1. A filter aid comprising: (a) an alkali silicate, and (b) a composite material comprising a silicate mineral at least partially coated with an inorganic silica or silicate.

2. The filter aid according to claim 1, wherein the alkali silicate comprises a sodium silicate, a potassium silicate, or a mixture thereof.

3. (canceled)

4. The filter aid according to claim 1, wherein the alkali silicate comprises sodium metasilicate pentahydrate, sodium metasilicate nonahydrate, anhydrous sodium metasilicate, or a mixture thereof.

5. (canceled)

6. (canceled)

7. The filter aid according to claim 1, wherein the silicate mineral comprises diatomaceous earth.

8. The filter aid according to claim 1, wherein the silicate mineral comprises perlite, pumice, pumicite, obsidian, pitchstone, volcanic ash, or a combination thereof.

9. The filter aid according to claim 1, wherein the alkali silicate comprises from about 10 to about 70% by weight of the filter aid.

10. The filter aid according to claim 1, wherein the inorganic silica or silicate comprises silica gel, sodium silicate, magnesium silicate, or a combination thereof.

11. The filter aid according to claim 1, wherein the inorganic silica or silicate is precipitated onto a surface of the silicate mineral.

12. The filter aid according to claim 1, wherein the composite material comprises from about 50% to about 95% by weight of biogenic silica.

13. The filter aid according to claim 1, wherein the composite material comprises from about 5% to about 80% by weight of the inorganic silica or silicate with respect to the total weight of the composite material.

14. The filter aid according to claim 1, wherein the filter aid has a permeability ranging from about 0.05 darcy to about 3.0 darcy and a BET surface area ranging from about 5 m²/q to about 450 m²/g.

15. (canceled)

16. (canceled)

17. The filter aid according to claim 1, wherein the composite material has a median pore diameter (4V/A) ranging from about 0.1 μm to about 10.0 μm, a particle size distribution with a d50 diameter ranging from about 5 μm to about 300 μm, and a wet density ranging from about 5 lb/ft3 to about 30 lb/ft3.

18-28. (canceled)

29. A filter aid comprising: (a) an alkali silicate, and (b) a silicate mineral, wherein at least a portion of the alkali silicate is present as a coating on the silicate mineral, and wherein the ratio of said alkali silicate to silicate mineral in the filter aid ranges from about 1:4 to 4:1 by weight.

30. The filter aid according to claim 29, wherein the alkali silicate comprises a sodium silicate, a potassium silicate, or a mixture thereof.

31-35. (canceled)

36. The filter aid according to claim 30, wherein the silicate mineral comprises perlite, pumice, pumicite, obsidian, pitchstone, volcanic ash, diatomaceous earth, or a combination thereof.

37. The filter aid according to claim 36, wherein the filter aid has a permeability ranging from about 0.05 darcy to about 10.0 darcy and a a BET surface area ranging from about 0.2 m²/q to about 450 m²/g.

38-45. (canceled)

46. A filter aid comprising an alkali silicate, a silicate mineral, and an adsorbent.

47. The filter aid of claim 46, comprising about 10% to about 60% by weight alkali silicate, about 10% to about 60% by weight silicate mineral, and about 10 to about 60% by weight adsorbent.

48. (canceled)

49. The filter aid of claim 46, wherein the adsorbent is a particulate material substantially unbound from the silicate mineral and wherein said adsorbent is at least partially coated onto the silicate mineral.

50-59. (canceled)

60. The filter aid according to claim 46, wherein the filter aid comprises from about 0.5% to about 20% by weight water, with respect to the total weight of the filter aid.

61-68. (canceled)
